(19) United States
(12) Patent Application Publication
(10) Pub. No.: US 2012/0095777 A1
(43) Pub. Date: Apr. 19, 2012

(54) PATIENT LIFT APPARATUS AND PATIENT LIFT SERVICE DISPATCH SYSTEM

(75) Inventors: Chao-Hsien Chang, New Taipei City (TW); Jeng-Han Li, Pingtung County (TW); Ju-Ping Fu, Hsinchu City (TW); Jyh-Ming Shy, Hsinchu City (TW); Shun-Chieh Cheng, Taichung City (TW)

(73) Assignee: INDUSTRIAL TECHNOLOGY RESEARCH INSTITUTE, Hsinchu (TW)

(21) Appl. No.: 13/273,235

(22) Filed: Oct. 14, 2011

Related U.S. Application Data
(60) Provisional application No. 61/392,943, filed on Oct. 14, 2010.

(30) Foreign Application Priority Data
Aug. 31, 2011 (TW) 100131335

(51) Int. Cl. A61G 7/10; G06Q 50/22

(52) U.S. Cl. 705/2; 5/87.1

(57) ABSTRACT

A patient lift apparatus designed to lift and transfer patients is provided. The patient lift apparatus includes a patient lift base and a modular patient support device removably connected to the patient lift base to support a patient. The patient lift base includes a cantilever element, a portal frame, three wheel assemblies, a hanging mechanism. The cantilever element is pivoted intersectionally with the portal frame. The three wheel assemblies are disposed at the bases of the cantilever element and the portal frame, as three bearing points. The hanging mechanism is pivoted to the top of the cantilever element and connected to the modular patient support device below. When the cantilever element and the portal frame are rotated relatively, the height, the shape and the positions of the bearing points of the patient lift apparatus are changed accordingly.

### CROSS-REFERENCE TO RELATED APPLICATION

This application claims the benefit of U.S. Provisional Application No. 61/392,943, filed on Oct. 14, 2010. This application also claims the priority benefit of Taiwan patent application serial no. 100131335, filed on Aug. 31, 2011. The entirety of each of the above-mentioned patent applications is hereby incorporated by reference herein and made a part of this specification.

### BACKGROUND OF THE DISCLOSURE

1. Technical Field

The disclosure relates to a patient lift apparatus designed to lift and transfer patients and a service dispatch service using the patient lift apparatus. More particularly, the disclosure relates to a patient lift apparatus capable of reducing the size of the base thereof effectively and enhancing the lifting stability.

2. Background

The aging of global population structure has become an unstoppable trend. According to related studies, the ratio of young and middle aged adults to seniors was 8 to 1 in 1950, and the ratio is expected to decrease to 5 to 1 in 2020 and 3 to 1 in 2050. To accommodate with the aging population, the number of medical care and nursing institutions must be increased rapidly and the labor force demand for caring of the elderly will also increase significantly. However, the elderly and the care staffs are exposed to risks such as falling, slipping, and work injuries in the long run due to factors including lack of care staffs, heavy workload, and inadequate facilities, which in turn leads to immeasurable costs to both of the hospitals and the patients, and the overall social resources.

From studies and statistic data reported in the United States, 1 out of every 2 physically disabled patients is injured by falling when moving from a hospital bed to a wheelchair. Also, 1 out of every 3 care staffs is injured from improper force exertion during the process of moving the patient. Therefore, an effective auxiliary tool must be created to facilitate patient care to prevent work injury in care staffs so that the care staffs are prevented from work injury and to ensure the safety of the patients.

Accordingly, patient lifts designed to facilitate the patient care have been created using conventional techniques. However, the concepts proposed fail to satisfy the need of the actual caring environment. Firstly, most of the conventional techniques involve gigantic and immobile bases and thus require large spaces for operation. These apparatuses are unsuitable for shuttling between hallways and hospital rooms and may obstruct other medical processes. Furthermore, most of the conventional techniques have complicated operation procedures and excessive mechanisms requiring manual adjustment and lack the assistance of a dynamic source and a compliant manipulation system. Consequently, more personnel need to participate in the caring, accidents happen in the lifting process easily, and the care staffs may injure from work. Finally, most of the conventional techniques do not provide adjustable modular patient support devices, such that care staffs can not put the patient support device on the patient with ease. This not only increases the difficulty of the operation, but also increases the discomfort of the patient which may be unbearable to patients under critical conditions. Moreover, most of the conventional techniques fail to provide a sufficient amount of or a variable amount of hanging points to lift the patient and lack precise rotation positioning control, and therefore can not conduct flexible changes according to the center of gravity, the figure, and the posture of the patient. As a result, the conventional patient lift apparatuses not only increase the discomfort of the patient, but also make the patient feel insecure with the uncontrollable turning motion during the lifting process when the hanging points are deficient. Also, the patient lift apparatuses can not be operated in small spaces.

According to the aforementioned, the safety and comfort of patients in the lift and transfer process can only be enhanced by building an adjustable modular patient support device which has a smaller base, flexible configuration, effortless and straight forward operation and is further co-operated with rotation positioning control. The workload and the work injuries of care staffs can thus be reduced simultaneously and the actual demand for caring is satisfied while meeting commercial success.

### SUMMARY

A patient lift apparatus designed to lift and transfer patients is introduced herein.

A patient lift service dispatch system configured to determine a dispatch schedule according to a usage requirement and dispatch a patient lift apparatus is introduced herein.

A patient lift base including a cantilever element, a portal frame, a hanging mechanism, and three wheel assemblies is introduced herein. The cantilever element includes a top, a neck, a bottom, and two opposite outer sides. The portal frame includes a top, two bottoms, and two opposite inner sides. The portal frame is pivoted to the two opposite outer sides of the cantilever element via the two opposite inner sides. The hanging mechanism is disposed on a base of the top of cantilever element rotatably. The hanging mechanism has a plurality of hanging connection points and a plurality of positions of the hanging connection points is changed by rotating the hanging mechanism. The three wheel assemblies are installed at the bottom of the cantilever element and the two bottoms of the portal frame respectively to move and steer the patient lift base. The three wheel assemblies are adopted as three bearing points of the patient lift base. When the cantilever element rotates relative to the portal frame, an included angle between the two is altered, so that a height of the cantilever element changes and the bottom of the cantilever element moves relative to the two bottoms of the portal frame. Here, a power driven strap winding device may be disposed on the hanging connection point. By winding and unwinding a plurality of straps, the patient lift apparatus may be facilitated and a hanging posture of a person being lifted can be adjusted so as to satisfy the need for rotation and comfortableness.

A patient lift apparatus including a cantilever element, a portal frame, a hanging mechanism, a modular patient support device and three wheel assemblies is introduced herein. The cantilever element includes a top, a neck, a bottom, and two opposite outer sides. The portal frame includes a top, two bottoms, and two opposite inner sides. The portal frame is pivoted to the two opposite outer sides of the cantilever element via the two opposite inner sides. The hanging mechanism is disposed on a base of the top of cantilever element rotatably. The hanging mechanism has a plurality of hanging connection points and a plurality of positions of the hanging connection points is changed by rotating the hanging mechanism. The modular patient support device is connected to the hanging connection points of the hanging mechanism to support a patient. The three wheel assemblies are installed at the bottom of the cantilever element and the two bottoms of the portal frame respectively to move and steer the patient lift apparatus. The three wheel assemblies are adopted as three bearing points of the patient lift apparatus. When the cantilever element rotates relative to the portal frame, an included angle between the two is altered, so that a height of the cantilever element changes and the bottom of the cantilever element moves relative to the two bottoms of the portal frame.

A patient lift service dispatch system including an internet system, at least one patient lift apparatus, at least one mobile device, and a dispatch server is introduced herein. The patient lift apparatus is designed to lift and transfer patients and includes a positioning and navigation module to position and navigate the patient lift apparatus. The mobile device is configured to generate a patient lift service request and send the patient lift service request through the internet system. The dispatch server is configured to receive the patient lift service request through the internet system. The dispatch server determines a dispatch schedule according to the patient lift service request and a usage status and a location distribution of the patient lift apparatus, and dispatches the patient lift apparatus according to the dispatch schedule.

In light of the foregoing, a patient lift apparatus suitable for a variety of circumstances, capable of reducing the size of the base and enhancing the lifting stability, and capable of lifting and transferring a patient in a safe and comfortable manner is provided in the disclosure. A patient lift service dispatch system configured to determine a dispatch schedule according to the patient lift service request and capable of dispatching the patient lift apparatus effectively is also provided in the disclosure.

Several exemplary embodiments accompanied with figures are described in detail below to further describe the disclosure in details.

### BRIEF DESCRIPTION OF THE DRAWINGS

The accompanying drawings are included to provide further understanding, and are incorporated in and constitute a part of this specification. The drawings illustrate exemplary embodiments and, together with the description, serve to explain the principles of the disclosure.

FIG. 1 is a three-dimensional schematic diagram illustrating a patient lift apparatus according to a first exemplary embodiment.

FIGS. 2A-2D are schematic diagrams illustrating an operation of the patient lift apparatus under various circumstances according to the first exemplary embodiment.

FIG. 3A is a schematic diagram illustrating a hanging mechanism according to the first exemplary embodiment.

FIG. 3B is a schematic diagram illustrating a connection of a hanging connection point adopting a strap winding device driven by power.

FIG. 3C is a schematic diagram illustrating a strap winding device used in one of a plurality of exemplary embodiments of the hanging connection point.

FIG. 4 is a schematic diagram illustrating three wheel assemblies according to the first exemplary embodiment.

FIG. 5 is a schematic diagram illustrating a pitch adjustment mechanism according to the first exemplary embodiment.

FIG. 6 is a schematic diagram illustrating a modular patient support device according to the first exemplary embodiment.

FIG. 7 is a schematic block diagram illustrating a compliant manipulation system according to a second exemplary embodiment.

FIGS. 8A-8E are schematic diagrams illustrating an operation of the compliant manipulation system under various circumstances according to the second exemplary embodiment.

FIG. 9 is a schematic diagram illustrating a touch display device according to the second exemplary embodiment.

FIG. 10 is a schematic diagram illustrating a patient lift service dispatch system according to a third exemplary embodiment.

### DETAILED DESCRIPTION OF DISCLOSED EMBODIMENTS

In one of the exemplary embodiments, a patient lift apparatus designed to lift and transfer patients is provided.

In one of the exemplary embodiments, a patient lift service dispatch system configured to determine a dispatch schedule according to a usage requirement and dispatch a patient lift apparatus is provided.

In one of the exemplary embodiments, a patient lift base including a cantilever element, a portal frame, a hanging mechanism, and three wheel assemblies is provided. The cantilever element includes a top, a neck, a bottom, and two opposite outer sides. The portal frame includes a top, two bottoms, and two opposite inner sides. The portal frame is pivoted to the two opposite outer sides of the cantilever element via the two opposite inner sides. The hanging mechanism is disposed on a base of the top of cantilever element rotatably. The hanging mechanism has a plurality of hanging connection points and a plurality of positions of the hanging connection points is changed by rotating the hanging mechanism. The three wheel assemblies are installed at the bottom of the cantilever element and the two bottoms of the portal frame respectively to move and steer the patient lift base. The three wheel assemblies are adopted as three bearing points of the patient lift base. When the cantilever element rotates relative to the portal frame, an included angle between the two is altered, so that a height of the cantilever element changes and the bottom of the cantilever element moves relative to the two bottoms of the portal frame.

In one exemplary embodiment, the patient lift base further includes a modular patient support device having a plurality of support sheets and a plurality of connection straps. The support sheets are connected to one another through a plurality of connection devices to support a patient. The modular patient support device is connected to a plurality of hanging connection points of the hanging mechanism via the connection straps. Each of the connection straps includes a length adjustment device.

In one exemplary embodiment, the support sheets include a back support sheet and two leg support sheets.

In one exemplary embodiment, the patient lift base further includes a pitch adjustment mechanism. The pitch adjustment mechanism is installed at the neck of the cantilever element to adjust a levelness of the hanging mechanism.

In one exemplary embodiment, the three wheel assemblies include a differential-driving wheel assembly and two idler wheel assemblies. The differential-driving wheel assembly is installed at the bottom of the cantilever element. The two idler wheel assemblies are installed at the two bottoms of the portal frame respectively.

In one exemplary embodiment, the portal frame includes an inverted U-shape frame, an inverted V-shape frame, or an inverted U-shape frame.

In one exemplary embodiment, the patient lift base further includes a plurality of compliance-sensing devices, a control unit, and a plurality of actuators. The compliance-sensing devices are arranged on a plurality of positions on the patient lift base to sense forces and directions of the positions. The control unit is configured to calculate a plurality of manipulation commands correspondingly according to the forces and directions received by the compliance-sensing devices. The actuators are configured to apply a plurality of dynamic forces compliantly on a plurality of parts corresponding to the actuators according to the manipulation commands.

In one exemplary embodiment, the positions arranged with the compliance-sensing devices include the hanging mechanism, the pitch adjustment mechanism, the top of the cantilever element, the neck of the cantilever element, and the top of the portal frame.

In one exemplary embodiment, the parts corresponding to the actuators include the cantilever element, the portal frame, the hanging mechanism, the pitch adjustment mechanism, and the three wheel assemblies.

In one exemplary embodiment, the patient lift base further includes a plurality of touch display devices configured to display a status information of the patient lift base, display a physiological information of the patient, and provide an operation interface of the patient lift base.

In one of the exemplary embodiments, a driving device such as a power driven strap winding device may be disposed on the hanging connection points of the hanging mechanism. By winding and unwinding a plurality of straps, the lifting of the patient lift base can be facilitated and a hanging posture of a patient can be adjusted so as to satisfy the need for rotation and comfortableness.

In one of the exemplary embodiments, a patient lift apparatus including a patient lift base and a modular patient support device is provided. In one embodiment, the patient lift base includes a cantilever element, a portal frame, a hanging mechanism, and three wheel assemblies. The cantilever element includes a top, a neck, a bottom, and two opposite outer sides. The portal frame includes a top, two bottoms, and two opposite inner sides. The portal frame is pivoted to the two opposite outer sides of the cantilever element via the two opposite inner sides. The hanging mechanism is disposed on a base of the top of cantilever element rotatably. The hanging mechanism has a plurality of hanging connection points and a plurality of positions of the hanging connection points is changed by rotating the hanging mechanism. The modular patient support device is connected to the hanging connection points of the hanging mechanism to support a patient. The three wheel assemblies are installed at the bottom of the cantilever element and the two bottoms of the portal frame respectively to move and steer the patient lift apparatus. The three wheel assemblies are adopted as three bearing points of the patient lift apparatus. When the cantilever element rotates relative to the portal frame, an included angle between the two is altered, so that a height of the cantilever element changes and the bottom of the cantilever element moves relative to the two bottoms of the portal frame. Here, a driving device such as a power driven strap winding device may be disposed on the hanging connection points of the hanging mechanism. By winding and unwinding a plurality of strap, the patient lift apparatus can be facilitated and a hanging posture of a person being lifted can be adjusted so as to satisfy the need for rotation and comfortableness.

In one of the exemplary embodiments, a patient lift service dispatch system including an internet system, at least one patient lift apparatus, at least one mobile device, and a dispatch server is introduced. The patient lift apparatus is designed to lift and transfer patients and includes a positioning and navigation module to position and navigate the patient lift apparatus. The mobile device is configured to generate a patient lift service request and send the patient lift service request through the internet system. The dispatch server is configured to receive the patient lift service request through the internet system. The dispatch server determines a dispatch schedule according to the patient lift service request, a usage status and a location distribution of the patient lift apparatus. The dispatch server dispatches the patient lift apparatus according to the dispatch schedule.

Accordingly, a patient lift apparatus suitable for a variety of circumstances, capable of reducing the size of the base and enhancing the lifting stability, and capable of lifting and transferring a patient in a safe and comfortable manner is provided in the disclosure. A patient lift service dispatch system configured to determine a dispatch schedule according to the patient lift service request and capable of dispatching the patient lift apparatus effectively is also provided in the disclosure.

Several exemplary embodiments accompanied with figures are described in detail below to further describe the disclosure in details.

### First Exemplary Embodiment

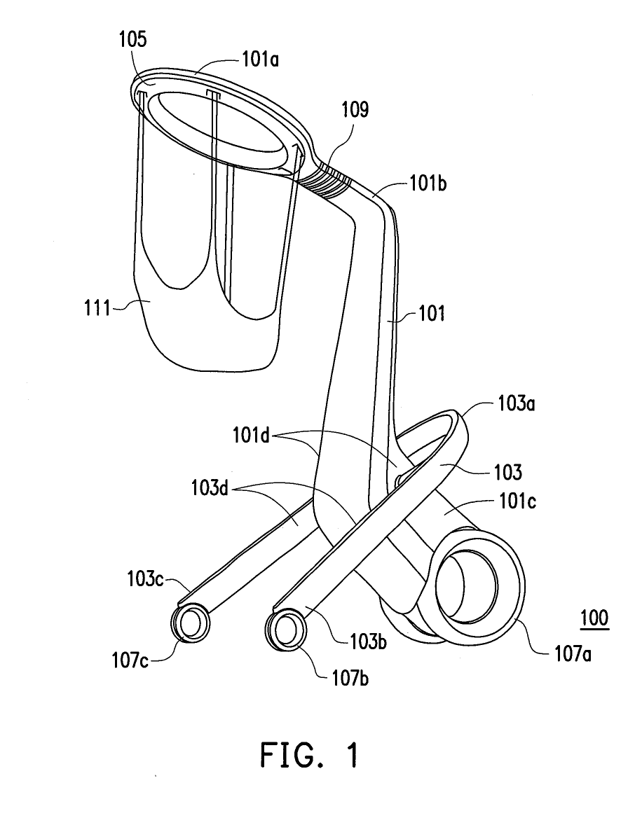

Referring to FIG. 1, FIG. 1 is a three-dimensional schematic diagram illustrating a patient lift apparatus according to a first exemplary embodiment.

Referring to FIG. 1, a patient lift apparatus 100 includes a cantilever element 101, a portal frame 103, a hanging mechanism 105, a differential-driving wheel assembly 107a, two idler wheel assemblies 107b-107c, a pitch adjustment mechanism 109, and a modular patient support device 111. The cantilever element 101 includes a top 101a, a neck 101b, a bottom 101c, and two opposite outer sides 101d. The portal frame 103 includes a top 103a, two bottoms 103b-103c, and two opposite inner sides 103d. The two opposite inner sides 103d of the portal frame 103 is pivoted to the two opposite outer sides 101d of the cantilever element 101. The hanging mechanism 105 is disposed on a base of the top 101a of cantilever element 101 rotatably. The differential-driving wheel assembly 107a and the idler wheel assemblies 107b-107c are installed at the bottom 101c of the cantilever element 101 and the two bottoms 103b-103c of the portal frame 103 respectively. The pitch adjustment mechanism 109 is installed at the neck 101b of the cantilever element 101. The modular patient support device 111 is connected to the hanging mechanism 105.

Specifically, the patient lift apparatus 100 adopts the differential-driving wheel assembly 107a and the idler wheel assemblies 107b-107c as three bearing points. When the cantilever element 101 rotates relative to the portal frame 103, an included angle between the two is altered, so that a height of the cantilever element 101 changes and the bottom 101c of the cantilever element 101 moves relative to the two bottoms 103b-103c of the portal frame 103.

It should be noted that the patient lift apparatus 100 applies the three wheel assemblies 107a-107c as three bearing points. Unlike the rectangular or U-shape base of the conventional patient lift apparatus, the three wheel assemblies 107a-107c can reduce the size of the base effectively and comply with the environment to be utilized in a limited space.

For example, when lifting a patient on a hospital bed, the wheel assemblies 107b-107c in the patient lift apparatus 100 can be pushed under the hospital bed to comply with the environment and utilize the space efficiently, so that the space occupied by the patient lift apparatus 100 is reduced.

In addition, when the cantilever element 101 rotates relative to the portal frame 103, an included angle between the two changes and a height of the cantilever element is changed accordingly. The bottom of the cantilever element 101 moves relative to the two bottoms 103b-103c of the portal frame 103 so as to change a lifting height of the patient lift apparatus 100 and a plurality of positions of the bearing points to satisfy a variety of circumstances. The circumstances include, for example, lifting the patient from a bed, lifting from a wheel chair, or lifting from a floor pad.

For example, when lifting a heavily weighted patient, the wheel assemblies 107b-107c in the patient lift apparatus 100 are extended beneath the patient as the bearing points to decrease the overturning moment and prevent flipping.

The operations of the patient lift apparatus 100 under various circumstances are described together with the drawings 2A-2D to better illustrate the disclosure.

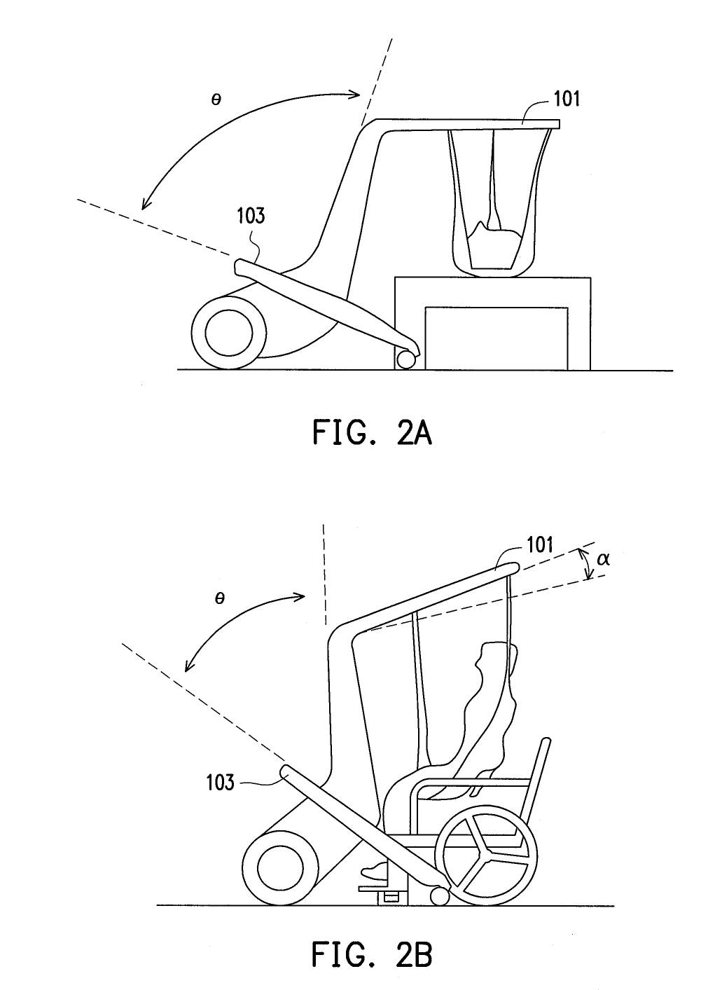

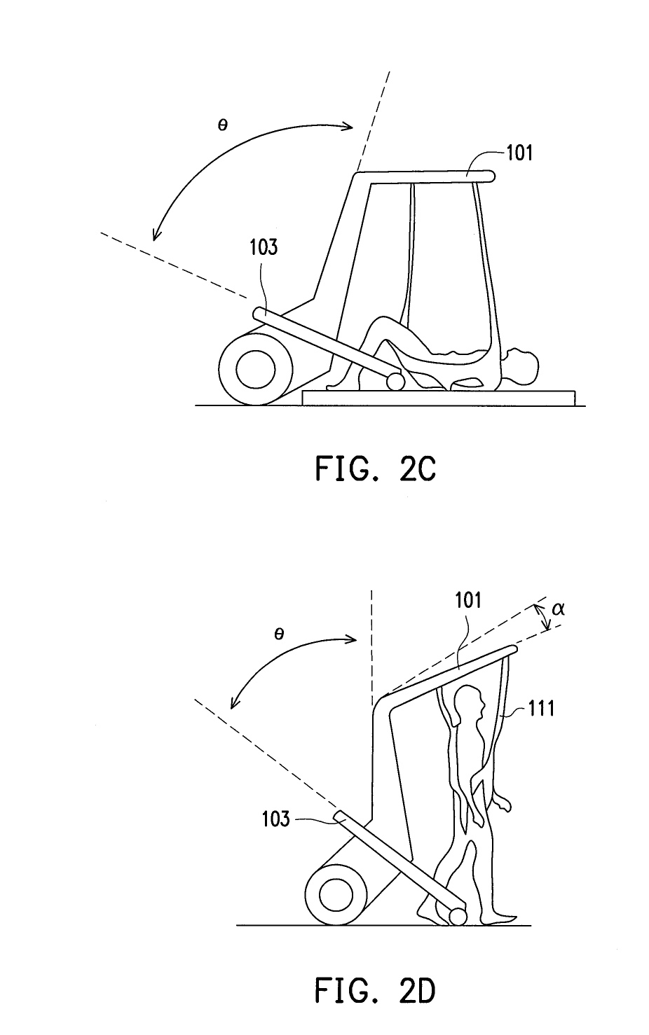

FIGS. 2A-2D are schematic diagrams illustrating an operation of the patient lift apparatus 100 under various circumstances according to the first exemplary embodiment.

Referring to FIG. 2A, when lifting a patient on a hospital bed, the patient lift apparatus 100 can change an included angle θ to adjust a height of the hospital bed. The assemblies 107b-107c are extended beneath the hospital bed to save the operation space and maintain balance.

Referring to FIG. 2B, when lifting a patient on a wheel chair, the patient lift apparatus 100 changes a lifting height slowly by changing an included angle θ so as to lift the patient slowly from the wheel chair. An included angle α can also be adjusted with the changes of the included angle θ correspondingly to maintain the levelness of the top 101a of the cantilever element 101 and ensure the patient's comfort and stability.

Referring to FIG. 2C, when lifting a patient on a floor, the patient lift apparatus 100 can expand an included angle θ as much as possible to lower a lifting height so as to reach the patient's location.

Referring to FIG. 2D, when assisting a patient to walk, for example, in a physiotherapeutic exercise, the patient lift apparatus 100 can decrease an included angle θ to extend a lifting height to comply with the patient's height. Also, an included angle α can also be adjusted with the changes of the included angle θ correspondingly to maintain the levelness of the top 101a of the cantilever element 101 and ensure the patient's comfort and stability. As the assemblies 107b and 107c are extended forwardly to two sides of the patient, the patient can walk without being blocked by the patient lift apparatus 100. Here, the modular patient support device 111 can also prevent the patient from falling when walking.

Moreover, when the patient lift apparatus 100 is idling (not shown), a care staff can also alter the included angle θ to adjust the configuration of the patient lift apparatus 100 according to the actual emplacement space or storage space.

It should be noted that in the exemplary embodiment, the portal frame 103 is an inverted U-shape frame. However, the disclosure is not limited thereto. In another embodiment of the disclosure, the portal frame 103 can also be an inverted V-shape frame or an inverted U-shape frame. Alternatively, the portal frame 103 can be any frame that can provide two bearing points for the patient lift apparatus 100 and be pivoted to the two opposite outer sides 101d of the cantilever element 101 from two opposite inner sides.

Additionally, in another exemplary embodiment of the disclosure, the two bottoms 103b and 103c of the portal frame 103 can also be designed as a frame with extendable length (not shown), so that the assemblies 107b and 107c can be extended forward when lifting a heavily weight patient to reduce the overturning moment from lifting. Furthermore, when lifting from a non-planar floor, the bearing stability of the patient lift apparatus 100 can be maintained with the frame of extendable length according to the principle of three points defines a plane.

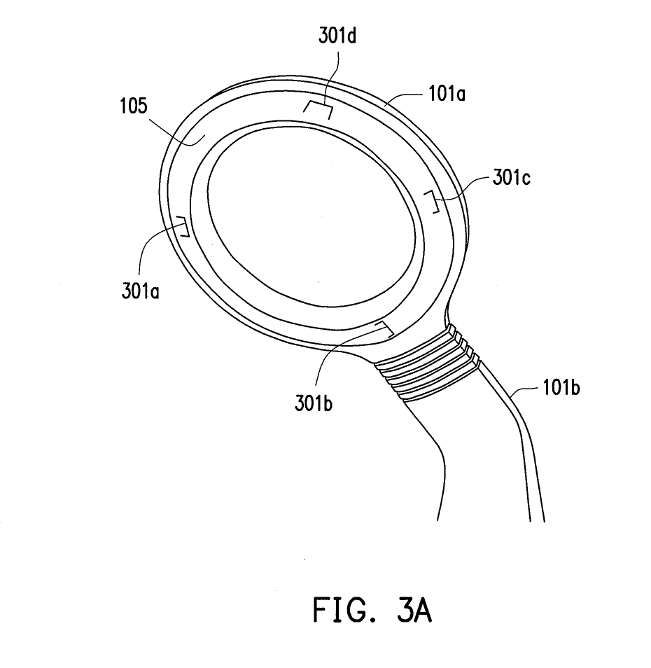

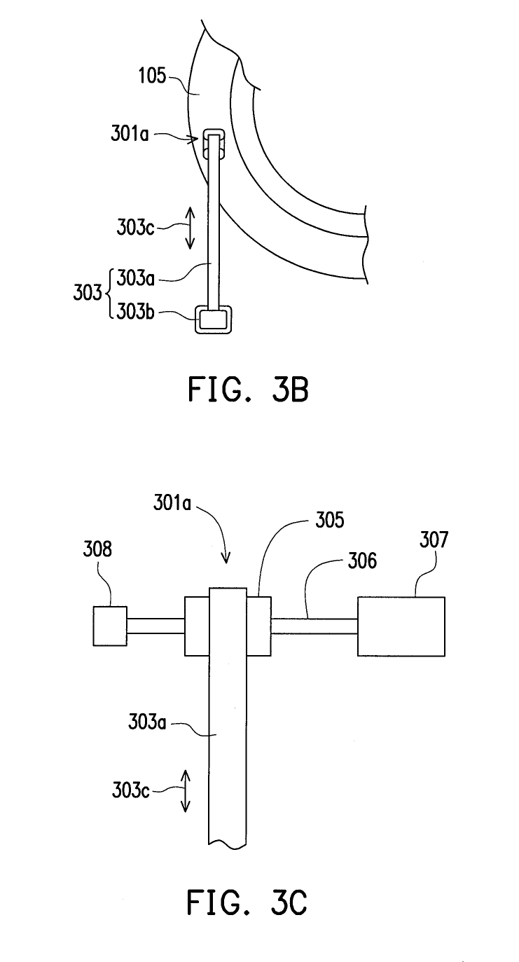

FIG. 3A is a schematic diagram illustrating a hanging mechanism according to the first exemplary embodiment.

Referring to FIG. 3A, the hanging mechanism 105 includes a plurality of hanging connection points 301a-301d. Here, a plurality of positions of the hanging connection points 301a-301d can be changed by rotating the hanging mechanism 105.

It should be noted that the patient lift apparatus 100 and the center of gravity of the patient can be adjusted with the positions of the bearing points of the patient lift apparatus 100 in coordination with the rotation of the hanging mechanism 105. When the patient lift apparatus 100 is fixed in a location, the patient can be turned using the hanging mechanism 105 to satisfy certain circumstances. For example, when assisting a patient on a wheel chair to the restroom, the patient lift apparatus 100 lifts the patient from the wheel chair to an appropriate height (as depicted in FIG. 2B) and transfers the patient to the restroom. Then, the patient lift apparatus 100 rotates the hanging mechanism 105, turns the patient, and lowers to an appropriate height to place the patient on the toilet.

It should be understood that in the exemplary embodiment, the hanging mechanism 105 is an annular frame. Nevertheless, the disclosure is not limited thereto. In another exemplary embodiment of the disclosure, the hanging mechanism 105 can also be a disc-shape frame or any frame that can be disposed on the base of the top 101a of the cantilever frame 101 rotatably.

Also, four hanging connection points 301a-301d are included in the exemplary embodiment; however, the disclosure is not limited thereto. In another exemplary embodiment of the disclosure, the number of the hanging connection points is determined by actual requirements and the hanging connection points are not limited to be fixed on the hanging mechanism 105.

In one exemplary embodiment, a driving device such as a power driven strap winding device may be disposed on the hanging connection point. By winding and unwinding a plurality of strap, the patient lift apparatus can be facilitated and a hanging posture of a person being lifted can be adjusted so as to satisfy the need for rotation and comfortableness.

In one of the exemplary embodiments, as shown in FIGS. 3B and 3C, for instance, the hanging connection point illustrates a power-driven strap winding device used in one of the exemplary embodiments of the hanging connection point. As shown in FIG. 3B, a schematic diagram illustrating a connection of a hanging connection point adopting a strap winding device driven by power is depicted. The hanging connection point 301a allows a user to hang a hanging assembly 303 on the hanging connection point 301a. The hanging assembly 303 includes a connection strap 303a and a buckle 303b. Here, only one of the hanging connection points and a hanging assembly are shown. The other hanging connection points can also adopt the same framework and the details are not reiterated hereinafter. Since the hanging connection point 301a is a strap winding device driven by power, the hanging assembly 303 can be moved up and down in directions shown with a notation 303c. The hanging mechanism 105 can be a disc-shape frame or any frame that can be disposed on the base of the cantilever frame 101 rotatably. Therefore, the lifting of the patient lift apparatus can be facilitated and the hanging posture of a person being lifted can be adjusted.

Referring to FIG. 3C, schematic diagram illustrating a strap winding device used in one of a plurality of exemplary embodiments of the hanging connection points. A hanging connection point 301a includes, for example, a connection part 305, a rotation axis 306, and a driving apparatus 307. A connection strap 303a of a hanging assembly 303 can be fixed on the connection part 305 detachably. One end of the rotation axis 306 is connected to the driving apparatus 307 while the other end of connected to a fixation part 308 rotatably. The driving apparatus 307 utilizes the rotation axis 306 to drive the connection part 305, thereby driving the connection strap 303a to move up and down by winding and unwinding. In one exemplary embodiment, the driving apparatus 307 has a lock function for locking apparatuses such as the rotation axis 306, the connection part 305 and so on when the driving power has failed or is turned off, so as to prevent the strap 303a from winding and unwinding improperly, thereby causing the patient to fall off from the patient lift apparatus.

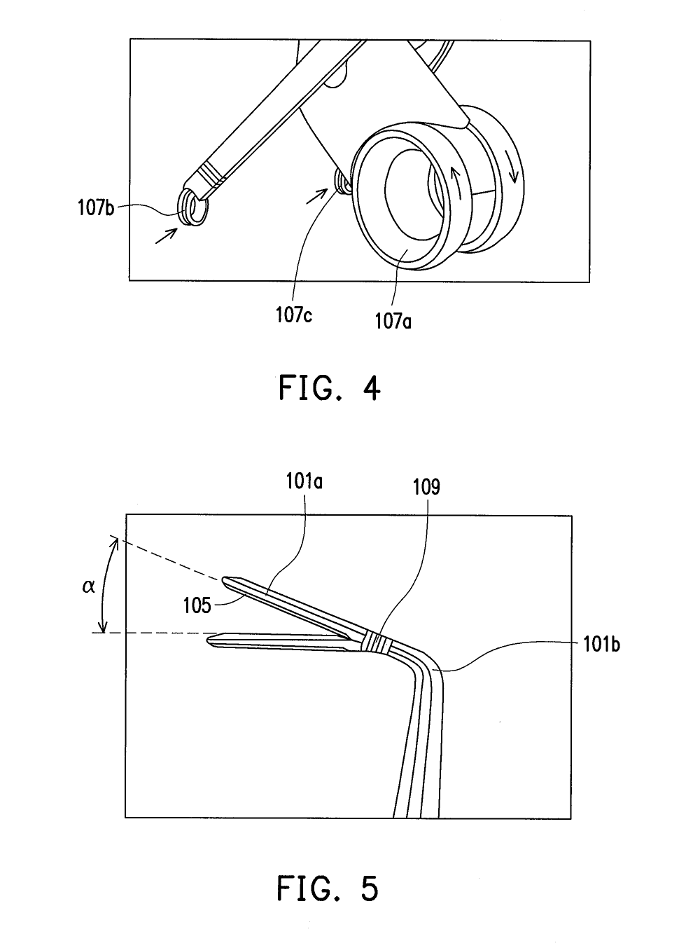

FIG. 4 is a schematic diagram illustrating three wheel assemblies according to the first exemplary embodiment.

Referring to FIG. 4, the differential-driving wheel assembly 107a and the idler wheel assemblies 107b-107c are configured to move and steer the patient lift apparatus 100 and are adopted as three bearing points of the patient lift apparatus 100.

Specifically, the patient lift apparatus 100 adopts the differential-driving wheel assembly 107a as a driving source and the idler wheel assemblies 107b and 107c as the bearing points at the front to maintain the balance of the patient lift apparatus 100. The differential-driving wheel assembly 107a includes two differential-driving wheels and can determine the moving forward, the backing up, and the turning of the patient lift apparatus 100 by utilizing a rotational direction and a speed difference of the two differential-driving wheels in coordination with the idler wheels 107b and 107c which can rotate 360° (that can comply with a moving direction of the patient lift apparatus 100 by changing a direction thereof).

For example, as shown in FIG. 4, when the two differential-driving wheels of the differential-driving wheel assembly 107a rotate in different directions respectively, the idler wheel assemblies 107b and 107c also change their direction and rotate accordingly so as to turn the patient lift apparatus 100.

It should be understood that in the exemplary embodiment, the idler wheel assemblies 107b and 107c do not have dynamic forces therein. Nonetheless, the disclosure is not limited thereto. In another exemplary embodiment of the disclosure, a small engine can also be disposed in the idler wheel assemblies 107b and 107c as a driving source to comply with particular ground levels. For instance, the small engine helps the patient lift apparatus 100 to transfer on an uneven carpet or bedding. The differential-driving wheel assembly 107a and the idler wheel assemblies 107b and 107c can also be replaced with active wheel assemblies to determine the moving forward, the backing up, and the turning of the patient lift apparatus 100.

FIG. 5 is a schematic diagram illustrating a pitch adjustment mechanism according to the first exemplary embodiment.

Referring to FIG. 5, the pitch adjustment mechanism 109 is disposed at the neck 101b of the cantilever element 101 and connected to the top 101a of the cantilever element 101 to adjust the levelness of the hanging mechanism 105 (that is, adjust the included angle α).

Specifically, when the included angle θ between the cantilever element 101 and the portal frame 103 changes (as shown in FIGS. 2A-2D), the levelness of the hanging mechanism 105 is affected. The care staff can adjust the levelness of the hanging mechanism 105 through the pitch adjustment mechanism 109 to maintain the posture and the center of gravity of the patient and make the patient comfortable.

FIG. 6 is a schematic diagram illustrating a modular patient support device according to the first exemplary embodiment.

Referring to FIG. 6, the modular patient support device 111 includes a back support sheet 601, two leg support sheets 602-603, and four connection straps 607a-607d. Herein, the back support sheet 601 and the two leg support sheets 602-603 are connected to one another through a plurality of connection devices (e.g. buckles) for assembling into an appropriate form to support a patient. Further, the modular patient support device 111 is connected to the hanging connection points 301a-301d of the hanging mechanism 105 via the connection straps 607a-607d (as depicted in FIG. 3). Each of the connection straps 607a-607d includes a length adjustment device to adjust the lengths of the connection straps 607a-607d accordingly.

Specifically, the modular structure allows the care staff to put the patient support device 111 on the patient to reduce the flipping of the patient or eliminate the need of other equipments for assistance.

For example, firstly, the care staff pushes the patient to lie on his/her side, places the back support sheet 601 on the back of the patient, and let the patient lay on his/her back. Thereafter, the leg support sheets 602-603 are placed around the left and right legs of the patient for support. A plurality of buckling tenons then connect the back support sheet 601 to the legs support sheets 602-603. Furthermore, the buckling tenons connect the leg support sheets 602-603 to the connection straps 607-607d. Finally, the connection straps 607a-607d are connected to the hanging connection points 301a-301d on the hanging mechanism 105. Additionally, the care staff can also adjust the lengths of the connection straps 607a-607d according to the patient's figure and posture to increase the stability and comfort of the lift and transfer process. Next, the patient can be lifted from the bed, the floor, or the wheel chair. On the contrary, after the patient lift apparatus 100 places the patient on the bed, the floor, or the wheel chair, the care staff unbuckles the buckling tenons connecting the modular patient support device and the hanging connection points 301a-301d. The care staff then unbuckles the buckling tenons connecting the back support sheet 601 and the leg support sheets 602-603. Afterwards, after the care staff pushes the patient on his/her side and removes the back support sheet 601, the patient is laid on his/her back to complete the lift and transfer process.

It should be noted that the connection straps 607a-607d share the weight of the patient to provide sufficient carrying capacity. Moreover, the connection straps 607a-607d provide sufficient hanging connection points to prevent the patient from being turned carelessly. In addition, the care staff can also adjust the patient's center of gravity and posture using the length adjustment devices on the connection straps 607a-607d so as to stabilize the lifting and make the patient feel more comfortable.

It should be understood that in the exemplary embodiment, the modular patient support device 111 merely includes three support sheets 601-603 and four connection straps 607a-607d. However, the disclosure is not limited thereto. In another exemplary embodiment of the disclosure, the modular patient support device 111 can include more support sheets and connection straps depending on actual circumstances.

In summary, the patient lift and transfer apparatus merely includes three bearing points in the disclosure, such that the size of the base and the operation space can be reduced effectively. The patient lift and transfer apparatus can also utilize the change in the included angle between the cantilever element and the portal frame to adjust the lifting height and change the relative distance between the bottoms of the portal frame and the bottom of the cantilever element so as to adjust the positions of the bearing points. The bearing points can be extended forward to reduce the overturning moment and thereby maintaining the balance of the center of gravity. The bearing points can be pushed backward to minimize the space occupied by the base for the patient lift apparatus to comply with the environment with flexibility.

Also, in the disclosure, the modular patient support device can be easily put on the patient by the care staff to overcome the inconvenience and difficulty in flipping patients. Additionally, multiple connection straps not only provide sufficient carrying capacity, but also prevent the patient from being turned carelessly in the lifting process. The center of gravity and posture of the patient can be adjusted through the length adjustment devices on the connection straps, the rotatable hanging devices, and the pitch adjustment mechanism to stabilize the lifting and make the patient feel more comfortable.

### Second Exemplary Embodiment

The first exemplary embodiment illustrates the basic operation of the patient lift apparatus. The exemplary embodiment illustrates how the care staff only needs to apply a small force for the patient lift apparatus to assist the lifting and transferring compliantly by utilizing a compliant control. In the exemplary embodiment, the basic operation of the patient lift apparatus is identical to that in the first exemplary embodiment and the details are thus omitted hereinafter. The compliant control is further described in the following.

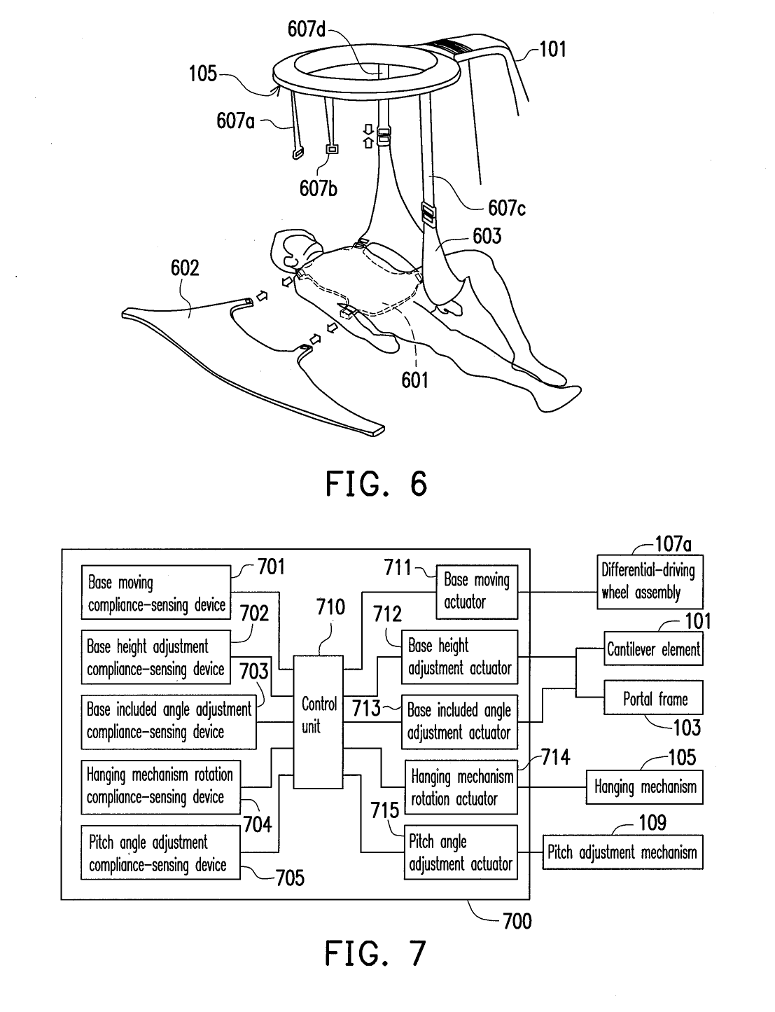

FIG. 7 is a schematic block diagram illustrating a compliant manipulation system according to a second exemplary embodiment.

Referring to FIG. 7, a compliant manipulation system 700 includes a plurality of compliance-sensing devices, a control unit 710, and a plurality of actuators.

For example, the compliance-sensing devices include a base moving compliance-sensing device 701, a base height adjustment compliance-sensing device 702, a base included angle adjustment compliance-sensing device 703, a hanging mechanism rotation compliance-sensing device 704, and a pitch angle adjustment compliance-sensing device 705.

Further, the actuators include a base moving actuator 711, a base height adjustment actuator 712, a base included angle adjustment actuator 713, a hanging mechanism rotation actuator 714, and a pitch angle adjustment actuator 715, for example.

The compliance-sensing devices are arranged on a plurality of positions on the patient lift apparatus 100 to sense forces and directions of the positions. The control unit 710 is coupled to the compliance-sensing devices 701-705 to receive the forces and directions sensed by the compliance-sensing devices 701-705 and calculate corresponding manipulation commands according to the same. The actuators 711-715 are coupled to the control unit 710 to receive a plurality of manipulation commands calculated by the control unit 710 and apply dynamic forces on corresponding parts compliantly according to the manipulation commands. For instance, the corresponding parts include the cantilever element 101, the portal frame 103, the hanging mechanism 105, the differential-driving wheel assembly 107a, and the pitch adjustment mechanism 109.

Specifically, the base moving actuator 711 controls the differential-driving wheel assembly 107a; the base height adjustment actuator 712 controls the cantilever element 101 and the portal frame 103; the base included angle adjustment actuator 713 controls the cantilever element 101 and the portal frame 103; the hanging mechanism rotation actuator 714 controls the hanging mechanism 105; and the pitch angle adjustment actuator 715 controls the pitch adjustment mechanism 109.

It should be understood that in the exemplary embodiment, the compliant manipulation system 700 includes five compliance-sensing devices, one control unit 710, and five actuators. However, the disclosure is not limited thereto. In another exemplary embodiment of the disclosure, the compliant manipulation system 700 can include more compliance-sensing devices and actuators depending on actual circumstances and control more corresponding parts.

The operations of the compliant manipulation system 700 under various circumstances are described together with the drawings 8A-8E to better illustrate the disclosure.

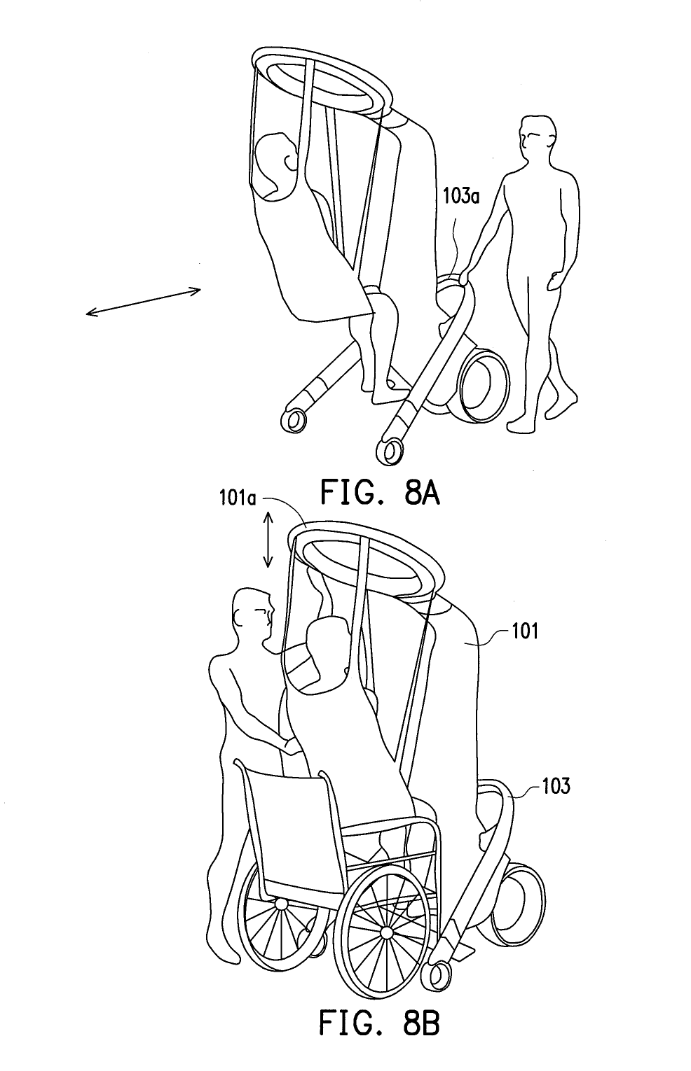

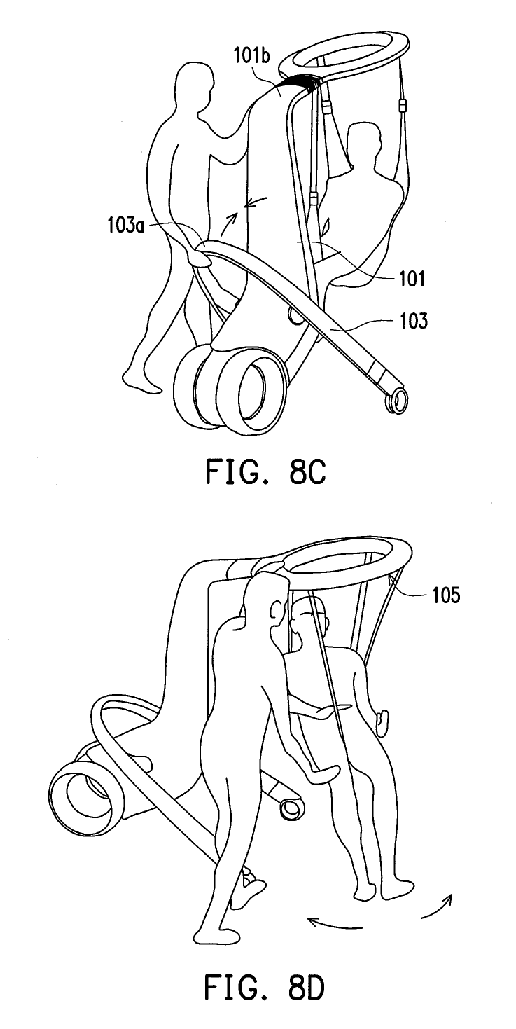

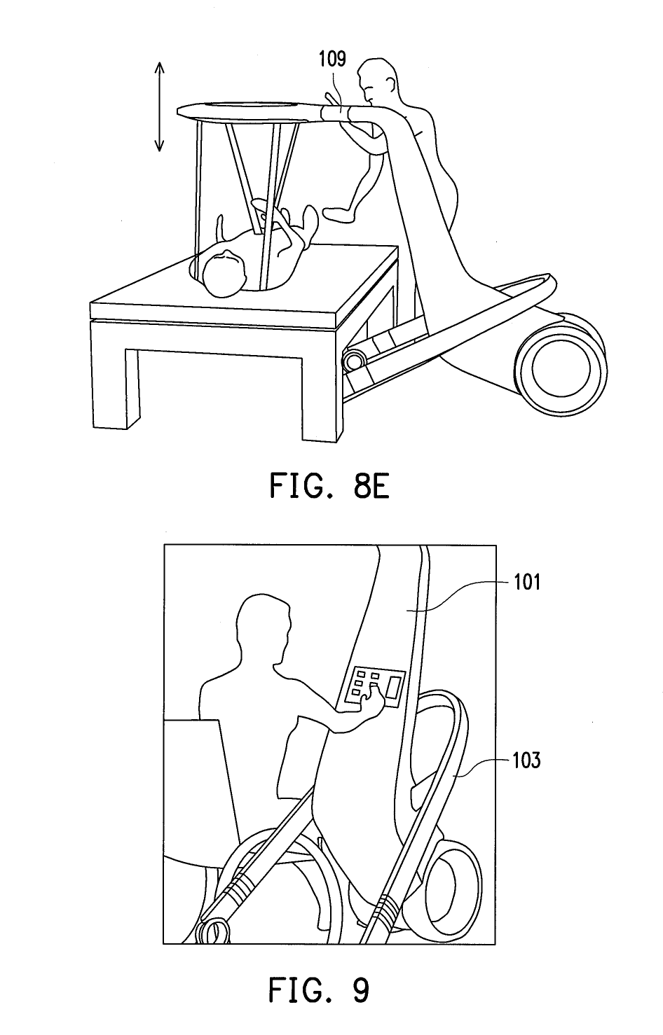

FIGS. 8A-8E are schematic diagrams illustrating an operation of the compliant manipulation system under various circumstances according to the second exemplary embodiment.

Referring to FIG. 8A, when the care staff wants to move the patient lift apparatus 100, the care staff only needs to apply a small force at the top 103a of the portal frame 103 toward the desirable moving direction. Afterwards, the base moving compliance-sensing device 701 arranged at the top 103a of the portal frame 103 can sense the force applied by the care staff and the direction of the force. The control unit 710 then determines the movement as a signal to move the patient lift apparatus 100, and calculates the corresponding manipulation command according to the force and the direction thereof. The manipulation command is then sent to the differential-driving wheel assembly 107a to move and steer the patient lift apparatus 100.

Referring to FIG. 8B, when the care staff wants to lift or lower the lifting height of the patient lift apparatus 100, the care staff only needs to apply a small force at the top 101a of the cantilever element 101 toward the desirable changing direction. Afterwards, the base height compliance-sensing device 702 arranged at the top 101a of the cantilever element 101 can sense the force applied by the care staff and the direction of the force. Next, the control unit 710 determines the movement as a signal to lift or lower the lifting height of the patient lift apparatus 100, and calculates the corresponding manipulation command according to the force and the direction thereof. The manipulation command is then sent to the cantilever element 101 and the portal frame 103 to change the included angle θ therebetween (as shown in FIGS. 2A-2D), thereby lifting or lowering the lifting height of the patient lift apparatus 100.

Referring to FIG. 8C, when the care staff wants to change the included angle θ of the patient lift apparatus 100 directly (as displayed in FIGS. 2A-2D), the care staff only needs to apply a small force at the top 103a of the portal frame 103 and the neck 101b of the cantilever element 101 simultaneously toward the desirable direction for altering the included angle θ. Afterwards, the base included angle adjustment compliance-sensing device 703 arranged at the neck 101b of the cantilever element 101 and the top 103a of the portal frame 103 can sense the force applied by the care staff and the direction of the force. The control unit 710 then determines the movement as a signal to alter the included angle θ of the patient lift apparatus 100, and calculates the corresponding manipulation command according to the force and the direction thereof. The manipulation command is then sent to the cantilever element 101 and the portal frame 103 to change the included angle θ therebetween.

Referring to FIG. 8D, when the care staff wants to rotate the hanging mechanism 105, the care staff only needs to apply a small force on a surface of the hanging mechanism 105 along the desirable rotation direction or drive the hanging mechanism 105 with the connection straps 607a-607d (as depicted in FIG. 6). Afterwards, the hanging mechanism rotation compliance-sensing device 704 arranged at the hanging mechanism 105 can sense the force applied by the care staff and the direction of the force. The control unit 710 then determines the movement as a signal to rotate the hanging mechanism 105, and calculates the corresponding manipulation command according to the force and the direction thereof Thereafter, the manipulation command is sent to the hanging mechanism 105 to rotate the hanging mechanism 105.

Referring to FIG. 8E, when the care staff wants to change a pitch angle of the pitch adjustment mechanism 109, the care staff only needs to apply a small force on the pitch adjustment mechanism 109 toward the desirable changing direction. Afterwards, the pitch angle adjustment compliance-sensing device 705 arranged at the pitch adjustment mechanism 109 can sense the force applied by the care staff and the direction of the force. The control unit 710 then determines the movement as a signal to change the pitch angle of the pitch adjustment mechanism 109, and calculates the corresponding manipulation command according to the force and the direction thereof. Thereafter, the manipulation command is sent to the pitch adjustment mechanism 109 to change the pitch angle of the pitch adjustment mechanism 109.

It should be understood that in the exemplary embodiment, the compliance-sensing device of the compliant manipulation system 700 and the corresponding parts are as those shown in FIGS. 8A-8E. Nevertheless, the disclosure is not limited thereto. In another exemplary embodiment of the disclosure, the compliance-sensing device can also be arranged at other positions according to various circumstances and correspond to other parts to be manipulated.

For instance, as illustrated above, in another exemplary embodiment of the disclosure, the two bottoms 103b and 103c of the portal frame 103 can also be designed as extendable parts (not shown). Therefore, when the care staff wants to extend or shorten those extendable parts, the care staff only needs to apply a small force at the two bottoms 103b and 103c of the portal frame 103 toward the direction for extending or shortening the parts. Afterwards, the compliance-sensing device arranged at the two bottoms 103b and 103c of the portal frame 103 can sense the force applied by the care staff and the direction of the force. The control unit 710 then determines the movement as a signal to extend or shorten the extendable parts, and calculates the corresponding manipulation command according to the force and the direction thereof. Thereafter, the manipulation command is sent to the extendable parts to extend or shorten the extendable parts.

FIG. 9 is a schematic diagram illustrating a touch display device according to the second exemplary embodiment.

Referring to FIG. 9, the patient lift apparatus 100 provides a plurality of touch display devices to display the status information of the patient lift apparatus (e.g. the battery level, the standby state, the current loading and so on) and the physiological information of the patient (e.g. the blood pressure, the heart rate, the oxygen concentration in blood and so on) as the information the care staff can refer to when operating the patient lift apparatus 100. Additionally, the patient lift apparatus 100 can also provide a touch display apparatus having an operation interface, so that the care staff can control the operation of the patient lift apparatus 100 on the touch display device. Alternatively, a touch display device including a digital content service is provided to the patient to enhance the service quality of the patient lift service for the patient to feel comfortable.

In summary, after the patient lift apparatus is used together with the compliant manipulation system in the disclosure, the care staff only needs to apply a small force for the patient lift apparatus to assist the care staff compliantly, so that the care staff can complete the lift and transfer process using in a straight forward manner. As a consequence, the safety of the patient is ensured in the lift and transfer process, the workload of the care staff is decreased, and the work injury of the care staff is avoided.

### Third Exemplary Embodiment

The first exemplary embodiment and the second exemplary embodiment illustrate the basic operation of the patient lift apparatus. The exemplary embodiment describes a service dispatch system adopting the patient lift apparatus. In the exemplary embodiment, the operation of the patient lift apparatus 100 is identical to those in the first and second exemplary embodiments and the details are thus omitted hereinafter. The patient lift service dispatch system is demonstrated in the following.

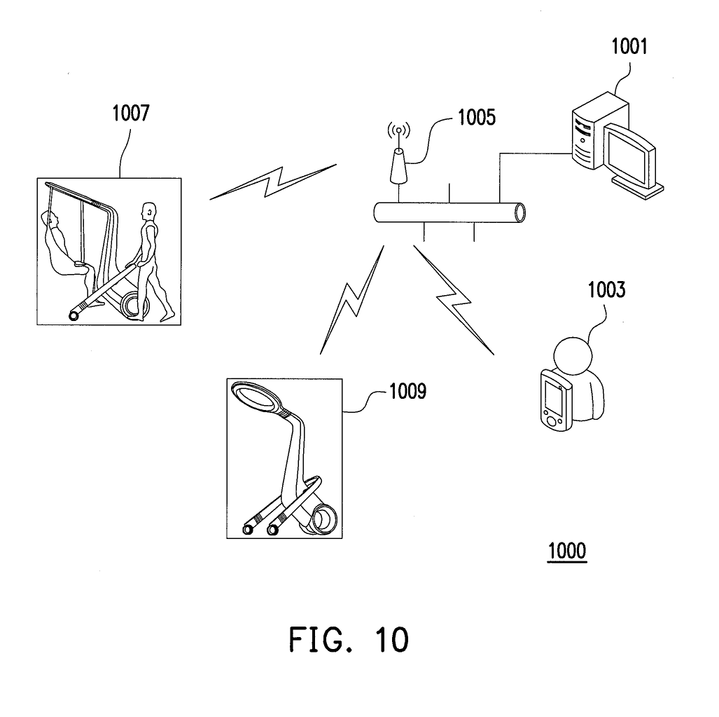

FIG. 10 is a schematic diagram illustrating a patient lift service dispatch system 1000 according to a third exemplary embodiment.

Referring to FIG. 10, the patient lift service dispatch system 1000 includes a dispatch server 1001, a mobile device 1003, an internet system 1005, and two patient lift apparatuses 1007 and 1009.

The patient lift apparatuses are designed to lift and transfer patients and each includes a positioning and navigation module to position and navigate the patient lift apparatuses 1007 and 1009. The mobile device 1003 is configured to generate a patient lift service request and send the patient lift service request through the internet system 105. The dispatch server 1001 is configured to receive the patient lift service request through the internet system 105. The dispatch server 1001 determines a dispatch schedule according to the patient lift service request and a usage status and a location distribution of the patient lift apparatuses 1007 and 1009. The dispatch server 1001 dispatches the patient lift apparatuses 1007 and 1009 according to the dispatch schedule.

Specifically, the care staff can use the mobile device 1003 to request or reserve a patient lift service, where the relevant requests are sent to the dispatch server 1001 through the internet system 1005. The patient lift apparatuses 1007 and 1009 continuously send the location and status information thereof (e.g. the battery remaining, the standby state, and so on) to the dispatch server 1001 through the internet system 1005. The dispatch server then determines the dispatch schedule according to the type of the patient lift service request (e.g. urgent, overdue, and so on) and parameters such as the locations and the status information of the patient lift apparatuses 1007 and 1009 to generate the most efficient dispatch schedule. For instance, the dispatch server 1001 can suitably plan service routes of the patient lift apparatuses 1007 and 1009 according to the monitoring of the remaining battery levels of the patient lift apparatuses 1007 and 1009, so that the patient lift apparatuses 1007 and 1009 can return to the charging station for charging when about time.

In summary, the patient lift service dispatch system can plan the dispatch schedule of multiple patient lift apparatuses efficiently with limited resources according to usage requirement.

It will be apparent to those skilled in the art that various modifications and variations can be made to the structure of the disclosed embodiments without departing from the scope or spirit of the disclosure. In view of the foregoing, it is intended that the disclosure cover modifications and variations of this disclosure provided they fall within the scope of the following claims and their equivalents.

What is claimed is:

1. A patient lift base, comprising:
a cantilever element, comprising a top, a neck, a bottom, and two opposite outer sides;
a portal frame comprising a top, two bottoms, and two opposite inner sides pivoted to the two opposite outer sides of the cantilever element;
a hanging mechanism disposed on a base of the top of the cantilever element rotatably, wherein the hanging mechanism comprises a plurality of hanging connection points and a plurality of positions of the hanging connection points is changed by rotating the hanging mechanism; and
three wheel assemblies, installed at the bottom of the cantilever element and the two bottoms of the portal frame respectively, configured to move and steer the patient lift base, and adopted as three bearing points of the patient lift base,
wherein when the cantilever element rotates relative to the portal frame, a height of the cantilever element changes and the bottom of the cantilever element moves relative to the two bottoms of the portal frame.

2. The patient lift base as claimed in claim 1, further comprising a modular patient support device, wherein the modular patient support device comprises:
a plurality of support sheets, connected to one another through a plurality of connection devices to support a patient; and
a plurality of connection straps, connected to the modular patient support device and the hanging connection points of the hanging mechanism, wherein the connection straps comprise a length adjustment device respectively.

3. The patient lift base as claimed in claim 2, wherein the support sheets comprise:
a back support sheet; and
two leg support sheets.

4. The patient lift base as claimed in claim 2, wherein the hanging connection point comprises a driving apparatus to drive the connection strap when connected to the connection strap.

5. The patient lift base as claimed in claim 4, wherein the hanging connection point further comprises a connection part and a rotation axis, where the connection part is connected to the connection strap detachably, and the driving apparatus drives the rotation axis so as to rotate the connection part and then move the connection strap.

6. The patient lift base as claimed in claim 5, wherein the driving apparatus has a lock function to lock the rotation axis and the connection part from moving when a driving power has failed or is turned off.

7. The patient lift base as claimed in claim 1, further comprising a pitch adjustment mechanism, installed at the neck of the cantilever element to adjust a levelness of the hanging mechanism.

8. The patient lift base as claimed in claim 1, wherein the three wheel assemblies comprise:
a differential-driving wheel assembly installed at the bottom of the cantilever element; and
two idler wheel assemblies installed at the two bottoms of the portal frame respectively.

9. The patient lift base as claimed in claim 1, wherein the portal frame comprises an inverted U-shape frame, an inverted V-shape frame, or an inverted U-shape frame.

10. The patient lift base as claimed in claim 1, further comprising:
a plurality of compliance-sensing devices arranged on a plurality of positions on the patient lift base to sense a plurality of forces and directions corresponding to the positions;
a control unit configured to calculate a plurality of manipulation commands correspondingly according to the forces and directions received by the compliance-sensing devices; and
a plurality of actuators configured to apply a plurality of dynamic forces compliantly on a plurality of parts corresponding to the actuators according to the manipulation commands.

11. The patient lift base as claimed in claim 10, wherein the positions arranged with the compliance-sensing devices comprise the hanging mechanism, the pitch adjustment mechanism, the top of the cantilever element, the neck of the cantilever element, and the top of the portal frame.

12. The patient lift base as claimed in claim 10, wherein the parts corresponding to the actuators comprise the cantilever element, the portal frame, the hanging mechanism, the pitch adjustment mechanism, and the three wheel assemblies.

13. The patient lift base as claimed in claim 1, further comprising a plurality of touch display devices, wherein the plurality of the touch display devices are configured to display a status information of the patient lift base, display a physiological information of the patient, and provide an operation interface of the patient lift base.

14. A patient lift apparatus, designed to lift and transfer patients, the patient lift apparatus comprising:
a patient lift base, comprising
a cantilever element comprising a top, a neck, a bottom, and two opposite outer sides;
a portal frame comprising a top, two bottoms, and two opposite inner sides pivoted to the two opposite outer sides of the cantilever element;
a hanging mechanism disposed on a base of the top of the cantilever element rotatably, wherein the hanging mechanism comprises a plurality of hanging connection points and a plurality of positions of the hanging connection points is changed by rotating the hanging mechanism;
and
three wheel assemblies, installed at the bottom of the cantilever element and the two bottoms of the portal frame respectively, configured to move and steer the patient lift base, and adopted as three bearing points of the patient lift base; and
a modular patient support device connected to the hanging connection points of the hanging mechanism to support a patient, wherein when the cantilever element rotates relative to the portal frame, a height of the cantilever element changes and the bottom of the cantilever element moves relative to the two bottoms of the portal frame.

15. The patient lift apparatus as claimed in claim 14, wherein the modular patient support device comprises:
a plurality of support sheets connected to one another through a plurality of connection devices to support a patient; and
a plurality of connection straps connected to the modular patient support device and the hanging connection points of the hanging mechanism, wherein the connection straps comprise a length adjustment device respectively.

16. The patient lift apparatus as claimed in claim 15, wherein the support sheets comprise:
a back support sheet; and
two leg support sheets.

17. The patient lift apparatus as claimed in claim 15, wherein the hanging connection point comprises a driving apparatus to drive the connection strap when connected to the connection strap.

18. The patient lift apparatus as claimed in claim 17, wherein the hanging connection point further comprises a connection part and a rotation axis, where the connection part is connected to the connection strap detachably, and the driving apparatus drives the rotation axis so as to rotate the connection part and then move the connection strap.

19. The patient lift apparatus as claimed in claim 18, wherein the driving apparatus has a lock function to lock the rotation axis and the connection part from moving when a driving power has failed or is turned off.

20. The patient lift apparatus as claimed in claim 14, further comprising a pitch adjustment mechanism installed at the neck of the cantilever element to adjust a levelness of the hanging mechanism.

21. The patient lift apparatus as claimed in claim 14, wherein the three wheel assemblies comprise:
a differential-driving wheel assembly installed at the bottom of the cantilever element; and
two idler wheel assemblies installed at the two bottoms of the portal frame respectively.

22. The patient lift apparatus as claimed in claim 14, wherein the portal frame comprises an inverted U-shape frame, an inverted V-shape frame, or an inverted U-shape frame.

23. The patient lift apparatus as claimed in claim 14, further comprising a compliant manipulation mechanism, wherein the compliant manipulation mechanism comprises:
a plurality of compliance-sensing devices arranged on a plurality of positions on the patient lift apparatus to sense a plurality of forces and directions corresponding to the positions;
a control unit configured to calculate a plurality of manipulation commands correspondingly according to the forces and directions received by the compliance-sensing devices; and
a plurality of actuators configured to apply a plurality of dynamic forces compliantly on a plurality of parts corresponding to the actuators according to the manipulation commands.

24. The patient lift apparatus as claimed in claim 23, wherein the positions arranged with the compliance-sensing devices comprise the hanging mechanism, the pitch adjustment mechanism, the top of the cantilever element, the neck of the cantilever element, and the top of the portal frame.

25. The patient lift apparatus as claimed in claim 23, wherein the parts corresponding to the actuators comprise the cantilever element, the portal frame, the hanging mechanism, the pitch adjustment mechanism, and the three wheel assemblies.

26. The patient lift apparatus as claimed in claim 14, further comprising a plurality of touch display devices configured to display a status information of the patient lift apparatus, display a physiological information of the patient, and provide an operation interface of the patient lift apparatus.

27. A patient lift service dispatch system, comprising:
an internet system;
at least one patient lift apparatus designed to lift and transfer a plurality of patients, wherein the at least one patient lift apparatus comprises a positioning and navigation module respectively to position and navigate the at least one patient lift apparatus;
at least one mobile device configured to generate at least one patient lift service request and send the at least one patient lift service request through the internet system; and
a dispatch server configured to receive the patient lift service requests through the internet system, determine a dispatch schedule according to the at least one patient lift service request and a usage status and a location distribution of the at least one patient lift apparatus, and dispatch the at least one patient lift apparatus according to the dispatch schedule.

28. The patient lift service dispatch system as claimed in claim 27, wherein the at least one patient lift apparatus respectively comprises a patient lift base and a modular patient support device removably connected to the patient lift base to support a patient, wherein
the patient lift base comprising
a cantilever element comprising a top, a neck, a bottom, and two opposite outer sides;
a portal frame comprising a top, two bottoms, and two opposite inner sides pivoted to the two opposite outer sides of the cantilever element;
a hanging mechanism disposed on a base of the top of the cantilever element rotatably, wherein the hanging mechanism comprises a plurality of hanging connection points and a plurality of positions of the hanging connection points is changed by rotating the hanging mechanism, wherein the modular patient support device is connected to the hanging connection points of the hanging mechanism; and
three wheel assemblies, installed at the bottom of the cantilever element and the two bottoms of the portal frame respectively, configured to move and steer the patient lift base, and adopted as three bearing points of the patient lift base,
wherein when the cantilever element rotates relative to the portal frame, a height of the cantilever element changes and the bottom of the cantilever element moves relative to the two bottoms of the portal frame.

29. The patient lift service dispatch system as claimed in claim 28, wherein the modular patient support device comprises:
a plurality of support sheets connected to one another through a plurality of connection devices to support a patient; and
a plurality of connection straps connected to the modular patient support device and the hanging connection points of the hanging mechanism, wherein the connection straps comprise a length adjustment device respectively.

30. The patient lift service dispatch system as claimed in claim 29, wherein the support sheets comprise:
a back support sheet; and
two leg support sheets.

31. The patient lift service dispatch system as claimed in claim 28, wherein the hanging connection point comprises a driving apparatus to drive the connection strap when connected to the connection strap.

32. The patient lift service dispatch system as claimed in claim 31, wherein the hanging connection point further comprises a connection part and a rotation axis, where the connection part is connected to the connection strap detachably, and the driving apparatus drives the rotation axis so as to rotate the connection part and then move the connection strap.

33. The patient lift service dispatch system as claimed in claim 32, wherein the driving apparatus has a lock function to lock the rotation axis and the connection part from moving when a driving power has failed or is turned off.

34. The patient lift service dispatch system as claimed in claim 28, wherein the at least one patient lift apparatus further comprises a pitch adjustment mechanism installed at the neck of the cantilever element to adjust a levelness of the hanging mechanism.

35. The patient lift service dispatch system as claimed in claim 29, wherein the three wheel assemblies comprise:
a differential-driving wheel assembly installed at the bottom of the cantilever element; and
two idler wheel assemblies installed at the two bottoms of the portal frame respectively.

36. The patient lift apparatus as claimed in claim 28, wherein the portal frame comprises an inverted U-shape frame, an inverted V-shape frame, or an inverted U-shape frame.

37. The patient lift service dispatch system as claimed in claim 28, wherein the at least one patient lift apparatus further comprises a compliant manipulation mechanism respectively, wherein the compliant manipulation mechanism comprises:
a plurality of compliance-sensing devices arranged on a plurality of positions on the patient lift apparatus to sense a plurality of forces and directions corresponding to the positions;
a control unit configured to calculate a plurality of manipulation commands correspondingly according to the forces and directions received by the compliance-sensing devices; and
a plurality of actuators configured to apply a plurality of dynamic forces compliantly on a plurality of parts corresponding to the actuators according to the manipulation commands.

38. The patient lift service dispatch system claimed in claim 37, wherein the positions arranged with the compliance-sensing devices comprise the hanging mechanism, the pitch adjustment mechanism, the top of the cantilever element, the neck of the cantilever element, and the top of the portal frame.

39. The patient lift service dispatch system as claimed in claim 37, wherein the parts corresponding to the actuators comprise the cantilever element, the portal frame, the hanging mechanism, the pitch adjustment mechanism, and the three wheel assemblies.

40. The patient lift service dispatch system as claimed in claim 28, wherein the at least one patient lift apparatus further comprises a plurality of touch display devices respectively to display a status information of the patient lift apparatus, display a physiological information of the patient, and provide an operation interface of the patient lift apparatus.
